(19) United States
(12) Patent Application Publication
(10) Pub. No.: US 2002/0176536 A1
(43) Pub. Date: Nov. 28, 2002

(54) Preparation of an oil sample fox X-ray fluorescence analysis

(76) Inventors: Yasuhiro Ayukawa, Osaka (JP); Megumi Ono, Osaka (JP)

Correspondence Address: BIRCH STEWART KOLASCH & BIRCH, PO BOX 747, FALLS CHURCH, VA, 22040-0747, US

(21) Appl. No.: 10/099,953

(22) Filed: Mar. 19, 2002

(30) Foreign Application Priority Data
Mar. 30, 2001 (JP) 2001-098779
Apr. 26, 2001 (JP) 2001-129757
Jan. 25, 2002 (JP) 2002-016862
Mar. 11, 2002 (JP) 2002-064860

(51) Int. Cl. G21K 5/08

(52) U.S. Cl. 378/66

(57) ABSTRACT

There is provided a method of preparing an oil sample for X-ray fluorescence analysis of the concentration of sulfur in the oil sample at a minimum limit of determination of about 10 to 30 ppb by concentrating sulfur through sedimentation or filtration. A liquid catalyst 15 from which S was removed almost completely is used, whereby S contained in an oil sample 16 is extracted, sedimented and concentrated as a silver sulfide-containing sulfur compound 18.

### BACKGROUND OF THE INVENTION

1. Field of the Invention

This invention relates to a method of preparing an oil sample for X-ray fluorescence analysis of the concentration of sulfur in the oil sample, etc.

2. Description of the Prior Art

For example, petroleum products such as propane, butane, gasoline, kerosine and light oil, or semi-finished petroleum products (also called base oils, which are LN, MN, HN, kerosine, solvent kerosine, LGO, MGO, HGO, etc.) serving as the starting materials for petroleum products, contain S in various forms. Typical examples include H₂S, R-SH, R-S-R, R-S-S-R, thiophene, benzothiophene, dibenzothiophene etc. (R is an alkyl group), and the form of S contained therein is also changed according to a difference in the boiling fraction of oil. For X-ray fluorescence analysis of S in such oil by a conventional method, the oil sample is charged into a liquid sample holder because the sample is liquid, and after a sample window of the sample holder is covered with a film (window material), the sample is analyzed by irradiation with primary X-rays in a He atmosphere.

At that time, the fluorescent X-rays of S are absorbed into He or the film, so that in the conventional method where the oil sample is measured as it is, S in a very small amount, that is, with faint fluorescent X-rays, cannot be measured satisfactorily, and hence, normally measurable range of quantitative concentration of S is greater than the order of several ppm while about 1 ppm is regarded as the minimum limit of determination in the analysis. Even by a micro coulometric titration or the like other than X-ray fluorescence analysis, about 100 ppb is the actual minimum limit of determination in analysis. Accordingly, the conventional method cannot sufficiently cope with analysis of a very small amount of S for severe quality control etc. in recent years.

### SUMMARY OF THE INVENTION

This invention was made in view of the problem in the prior art, and the object of this invention is to provide a method of preparing an oil sample for X-ray fluorescence analysis at a minimum limit of determination of about 10 to 30 ppb by concentrating S in the oil sample by sedimentation or filtration.

To achieve the object, a first aspect of this invention is a liquid catalyst used in a method of preparing. an oil sample for X-ray fluorescence analysis of the concentration of sulfur in the oil sample, which is prepared by removing silver acetate, and silver sulfide-containing silver compounds and silver precipitated by irradiation with electromagnetic waves or corpuscular rays, by filtration from a mixed solution of a silver nitrate solution having silver nitrate dissolved in a solvent and a sodium acetate solution having sodium acetate dissolved in the solvent.

The present inventors found that although S should be extracted and concentrated by use of a commercial reagent in X-ray fluorescence analysis of S contained in a very small amount in an oil sample, S contained in such a commercial reagent cannot be neglected when the concentration of S in the oil sample is as very low as 10 ppb or so. Accordingly, the first aspect of this invention is a liquid catalyst from which S has been removed almost completely so as not to hinder analysis of S in a very small amount of 10 ppb or so.

When an oil sample is prepared using the liquid catalyst in the first aspect of this invention and analyzed for S by X-ray fluorescence, S contained as an impurity in the liquid catalyst cannot be problematic, and S in a very small amount of about 10 ppb can be analyzed. This liquid catalyst is used preferably for an oil sample such as a petroleum product, a semi-finished petroleum product serving as the starting material thereof or a C₁₋₈ alcohol, and in this case, the solvent in the liquid catalyst is preferably a petroleum product, a semi-finished petroleum product serving as the starting material thereof or a C₁₋₈ alcohol for the catalyst. In this invention, the oil sample as the object of analysis can be a petroleum product, a semi-finished petroleum product serving as the starting material thereof or a C₁₋₈ alcohol, and for discrimination from such oil samples, the solvent used in production of the liquid catalyst is referred to as a petroleum product for the catalyst, a semi-finished petroleum product for the catalyst or an alcohol for the catalyst. Further, the silver compounds refer to both inorganic and organic silver compounds.

A second aspect of this invention is a method of producing the liquid catalyst in the first aspect of this invention, and follows the procedures described below. First, a silver nitrate solution having silver nitrate dissolved in a solvent is mixed with a sodium acetate solution having sodium acetate dissolved in the solvent, to form silver acetate. Then, the mixed solution is subjected to first filtration to remove the silver acetate. Then, the solution is irradiated with electromagnetic waves or corpuscular rays to precipitate silver sulfide-containing silver compounds and silver. Then, the solution is subjected to second filtration to remove the silver compounds and silver. Then, a nitrogen gas is allowed to flow into the solution to remove dissolved oxygen. Finally, an aldehyde or ammonia is added for preventing oxidation and improving the long-term shelf life.

According to the production method in the second aspect of this invention, the liquid catalyst in the first aspect of this invention can be produced, and further a deterioration in the performance thereof during storage can be reduced by preventing oxidation. The method of producing the liquid catalyst is used preferably when the oil sample is a petroleum product, a semi-finished petroleum product serving as the starting material thereof or a C₁₋₈ alcohol, and in this case, the solvent in the liquid catalyst is preferably a petroleum product, a semi-finished petroleum product serving as the starting material thereof or a C₁₋₈ alcohol for the catalyst, and the aldehyde is preferably formaldehyde, acetaldehyde or benzaldehyde. Further, as the electromagnetic waves or corpuscular rays, may be employed X-rays having longer wavelengths than the L absorption edge wavelength of silver and containing the absorption edge wavelength of sulfur.

A third aspect of this invention is an apparatus for producing the liquid catalyst in the first aspect of this invention, which comprises a radiation source for purifying the catalyst, to irradiate the mixed solution with the electromagnetic wavers or corpuscular rays in order to precipitate the silver sulfide-containing silver compounds and silver.

According to the apparatus in the third aspect of this invention, the mixed solution is irradiated with the electromagnetic waves or corpuscular rays to precipitate the silver sulfide-containing silver compounds and silver, in order to produce the liquid catalyst in the first aspect of the invention. The radiation source for purifying the catalyst can be an X-ray source for purifying the catalyst, to irradiate X-rays having longer wavelengths than the L absorption edge wavelength of silver and containing the absorption edge wavelength of sulfur.

A fourth aspect of this invention is a method of preparing an oil sample for X-ray fluorescence analysis of the concentration of sulfur in the oil sample, and follows the procedures described below. First, a nitrogen gas is allowed to flow into the liquid catalyst in the first aspect of this invention to remove dissolved oxygen. Then, the liquid catalyst is added to the oil sample collected in a sample holder and then stirred. Then, the stirred solution is irradiated with electromagnetic waves or corpuscular rays to precipitate silver sulfide-containing silver compounds and silver. Then, ammonia or an aldehyde is further added to dissolve silver compounds and silver other than silver sulfide-containing sulfur compounds, whereby the silver sulfide-containing sulfur compounds are left as precipitates on a window in the bottom of the sample holder.

According to the fourth aspect of this invention, the liquid catalyst from which S was almost completely removed according to the first aspect of this invention is used whereby S contained in the oil sample is extracted, sedimented and concentrated, and therefore fluorescent X-ray intensity enough to measure S can be obtained to analyze S in a very small amount of about 10 ppb. The method of preparing the oil sample is used preferably for an oil sample such as a petroleum product, a semi-finished petroleum product serving as the starting material thereof or a C₁₋₈ alcohol, and in this case, the solvent in the liquid catalyst is preferably a petroleum product, a semi-finished petroleum product serving as the starting material thereof or a C₁₋₈ alcohol for the catalyst. Further, as the electromagnetic waves or corpuscular rays, may be employed X-rays having longer wavelengths than the L absorption edge wavelength of silver and containing the absorption edge wavelength of sulfur.

A fifth aspect of this invention is an X-ray fluorescence spectrometer for analyzing the concentration of sulfur in an oil sample by the preparation method in the fourth aspect of this invention, which comprises a pretreatment X-ray source for downward irradiating the stirred solution with the electromagnetic waves or corpuscular rays and an analytical X-ray source for upward irradiating a window in the bottom of the sample holder with primary X-rays.

According to the X-ray fluorescence spectrometer in the fifth aspect of this invention, the irradiation with electromagnetic waves or corpuscular rays for preparation (pretreatment) in the fourth aspect of the invention, and the irradiation with primary X-rays for analysis of the oil sample prepared, can be carried out in one spectrometer. Accordingly, S in a very small amount of about 10 ppb can be analyzed in simple construction. This X-ray fluorescence spectrometer is used preferably for an oil product such as a petroleum product, a semi-finished petroleum product serving as the starting material thereof or a C₁₋₈ alcohol, and in this case, the solvent in the liquid catalyst is preferably a petroleum product, a semi-finished petroleum product serving as the starting material thereof or a C₁₋₈ alcohol for the catalyst. Further, as the electromagnetic waves or corpuscular rays, may be employed X-rays having longer wavelengths than the L absorption edge wavelength of silver and containing the absorption edge wavelength of sulfur, or X-rays monochromated in the absorption edge wavelength of sulfur.

A sixth aspect of this invention is a method of preparing an oil sample for X-ray fluorescence analysis of the concentration of sulfur in the oil sample, and follows the procedures described below. First, a nitrogen gas is allowed to flow into the liquid catalyst in the first aspect of the invention to remove dissolved oxygen. Then, the liquid catalyst is added to the oil sample and then stirred. Then, the stirred solution is irradiated with electromagnetic waves or corpuscular rays and further filtered through a filter membrane, to separate silver sulfide-containing sulfur compounds and silver on the filter membrane.

According to the preparation method in the sixth aspect of the invention, the liquid catalyst from which S was almost completely removed according to the first aspect of the invention is used whereby S contained in the oil sample is extracted, filtered and concentrated, and therefore fluorescent X-ray intensity enough to measure S is obtained, but unlike the preparation method in the fourth aspect of the invention, re-dissolution of precipitates other than sulfur compounds is not conducted. Accordingly, the minimum limit of determination is made about 15 ppb, but a very small amount of S can also be analyzed and the measurement sample can be prepared rapidly and easily. Further, unlike the preparation method in the fourth aspect of the invention, S contained in the oil sample is concentrated by filtration, and thus the measurement sample can be prepared more rapidly without waiting sedimentation, and further S contained in the oil sample is not precipitated on the window in the bottom of the sample holder, but separated and stuck as solid on the filter membrane, and can thus be analyzed by the X-ray fluorescence spectrometer for not only upward but also downward irradiation. This method of preparing the oil sample can be used preferably for an oil sample such as a petroleum product, a semi-finished petroleum product serving as the starting material thereof or a C₁₋₈ alcohol, and in this case, the solvent in the liquid catalyst is preferably a petroleum product, a semi-finished petroleum product serving as the starting material thereof or a C₁₋₈ alcohol for the catalyst. Further, as the electromagnetic waves or corpuscular rays, may be employed X-rays having longer wavelengths than the L absorption edge wavelength of silver and containing the absorption edge wavelength of sulfur.

A seventh aspect of the invention is a method of preparing an oil sample for X-ray fluorescence analysis of the concentration of sulfur in the oil sample, and follows the procedures described below. First, a silver nitrate solution having silver nitrate dissolved in a solvent and a sodium acetate solution having sodium acetate dissolved in the solvent are added as a liquid catalyst to the oil sample collected in a sample holder and then stirred. Then, the stirred solution is irradiated with electromagnetic waves or corpuscular rays to precipitate silver sulfide-containing silver compounds and silver on a window in the bottom of the sample holder.

According to the preparation method in the seventh aspect of the invention, S contained in the oil sample is extracted, sedimented and concentrated, and therefore fluorescent X-ray intensity enough to measure S is obtained, but unlike the preparation method in the fourth aspect of the invention, removal of S contained in the reagents and re-dissolution of precipitates other than sulfur compounds are not conducted. Accordingly, the minimum limit of determination is made about 30 ppb, but a small amount of S can also be analyzed and the measurement sample can be prepared rapidly and easily. This method of preparing the oil sample can also be used preferably for an oil sample such as a petroleum product, a semi-finished petroleum product serving as the starting material thereof or a C₁₋₈ alcohol, and in this case, the solvent in the liquid catalyst is preferably a C₁₋₈ alcohol for the catalyst. Further, as the electromagnetic waves or corpuscular rays, may be employed X-rays having longer wavelengths than the L absorption edge wavelength of silver and containing the absorption edge wavelength of sulfur, or X-rays monochromated in the absorption edge wavelength of sulfur.

An eighth aspect of the invention is a method of preparing an oil sample for X-ray fluorescence analysis of the concentration of sulfur in the oil sample, and follows the procedures described below. First, a silver nitrate solution having silver nitrate dissolved in a solvent and a sodium acetate solution having sodium acetate dissolved in the solvent are added as a liquid catalyst to the oil sample and then stirred. Then, the stirred solution is irradiated with electromagnetic waves or corpuscular rays and further filtered through a filter membrane to separate silver sulfide-containing silver compounds and silver on the filter membrane.

According to the preparation method in the eighth aspect of the invention, S contained in the oil sample is extracted, filtered and concentrated, and therefore fluorescent X-ray intensity enough to measure S is obtained, but like the preparation method in the seventh aspect of the invention, removal of S contained in the reagents and re-dissolution of precipitates other than sulfur compounds are not conducted. Accordingly, the minimum limit of determination is made about 30 ppb, but a small amount of S can also be analyzed and the measurement sample can be prepared rapidly and easily. Further, unlike the preparation method in the seventh aspect of the invention, S contained in the oil sample is concentrated by filtration, and thus the measurement sample can be prepared more rapidly without waiting sedimentation, and further S contained in the oil sample is not precipitated on the window in the bottom of the sample holder, but separated and stuck as solid on the filter membrane, and can thus be analyzed by the X-ray fluorescence spectrometer for not only upward but also downward irradiation. This method of preparing the oil sample can also be preferably used for an oil sample such as a petroleum product, a semi-finished petroleum product serving as the starting material thereof or a C₁₋₈ alcohol, and in this case, the solvent in the liquid catalyst is preferably a C₁₋₈ alcohol for the catalyst. Further, as the electromagnetic waves or corpuscular rays, may be employed X-rays having longer wavelengths than the L absorption edge wavelength of silver and containing the absorption edge wavelength of sulfur, or X-rays monochromated in the absorption edge wavelength of sulfur.

A ninth aspect of the invention is an X-ray fluorescence analysis method for analyzing the concentration of sulfur in the oil sample, and follows the procedures described below. First, a silver nitrate solution having silver nitrate dissolved in a solvent and a sodium acetate solution having sodium acetate dissolved in the solvent are added as a liquid catalyst to the oil sample collected in a sample holder, and then stirred. Then, the stirred solution is irradiated upward via a window in the bottom of the sample holder with primary X-rays to precipitate silver sulfide-containing silver compounds and silver on the window, and simultaneously the intensities of fluorescent X-rays emitted from the oil sample are measured.

According to the X-ray fluorescence analysis method in the ninth aspect of this invention, the irradiation with X-rays for preparation (pretreatment) in the seventh aspect of the invention, and the irradiation with primary X-rays for analysis of the oil sample prepared, can be simultaneously carried out by the conventional X-ray fluorescence spectrometer for upward irradiation. Accordingly, S in a very small amount of about 30 ppb can be analyzed rapidly and simply. This X-ray fluorescence analysis method can be used for an oil sample such as a petroleum product, a semi-finished petroleum product serving as the starting material thereof or a C₁₋₈ alcohol, and in this case, the solvent in the liquid catalyst is preferably a C₁₋₈ alcohol for the catalyst.

### BRIEF DESCRIPTION OF THE DRAWINGS

This invention will be clearly understood from the description of the following preferable embodiments by reference to the attached drawings. However, the embodiments and drawings are given only for the purpose of illustration and explanation, and should not be utilized to define the scope of this invention. The scope of this invention shall be defined by the appended claims. In the accompanying drawings, the same element number in a plurality of drawings refers to the same element.

FIGS. 1A and 1B show in combination a flowchart of a method of producing a liquid catalyst used in the method of preparing an oil sample for X-ray fluorescence analysis in a first embodiment of this invention.

FIG. 2 is a flowchart showing the method of preparing an oil sample for X-ray fluorescence analysis in the first embodiment of this invention.

FIG. 3 is an illustration showing one example of an X-ray fluorescence spectrometer for analyzing the concentration of sulfur in an oil sample by the preparation method.

FIG. 4 is one example of the calibration curve prepared by the preparation method.

FIG. 5 is a flowchart showing the X-ray fluorescence analysis method in the third embodiment of this invention.

FIG. 6 shows one example of the calibration curve prepared by the analysis method.

FIG. 7 is a schematic sectional view showing suction filtration in the method of preparing an oil sample for X-ray fluorescence analysis in the second or fourth embodiment of this invention.

FIG. 8 is a schematic sectional view showing X-ray fluorescence analysis of a material separated on a filter membrane by suction filtration in the preparation method.

FIG. 9 is a schematic sectional view showing pressure filtration in place of suction filtration in the preparation method.

FIG. 10 is a schematic sectional view showing a material separated on a filter membrane by pressure filtration in the preparation method.

FIG. 11 is a schematic sectional view showing X-ray fluorescence analysis of a material separated on a filter membrane by pressure filtration in the preparation method.

### DETAILED DESCRIPTION OF THE EMBODIMENTS

Hereinafter, the first embodiment of the invention, that is, the method of preparing an oil sample (corresponding to the fourth aspect of the invention) is described. This preparation method is a method of preparing an oil sample such as a petroleum product, a semi-finished product or C₁₋₈ alcohol for X-ray fluorescence analysis of the concentration of sulfur in the oil sample, and in this method, a liquid catalyst is used. This liquid catalyst is an embodiment corresponding to the first aspect of the invention, which is prepared by removing silver acetate, and silver sulfide-containing silver compounds and silver precipitated by irradiation with electromagnetic waves or corpuscular rays, by filtration from a mixture of a silver nitrate solution having silver nitrate dissolved in a solvent and a sodium acetate solution having sodium acetate dissolved in the solvent.

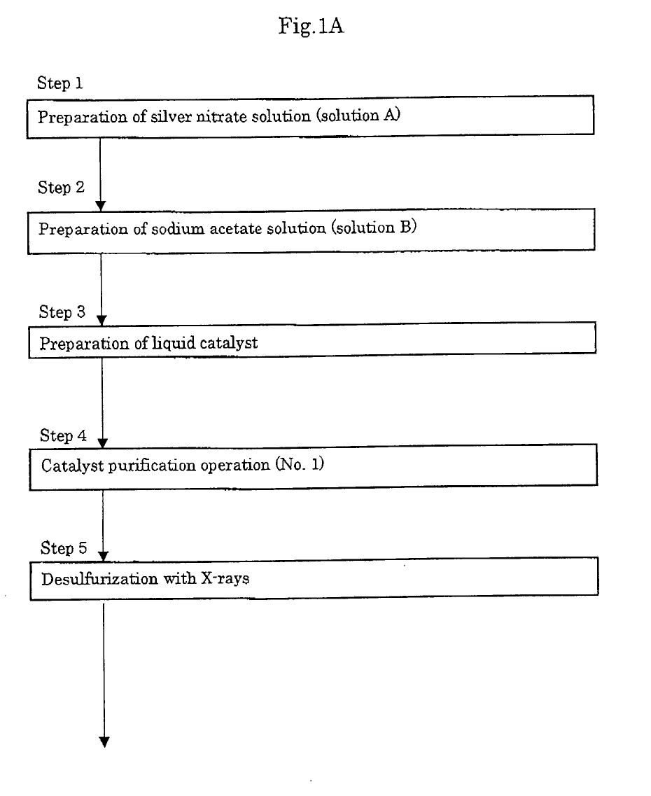

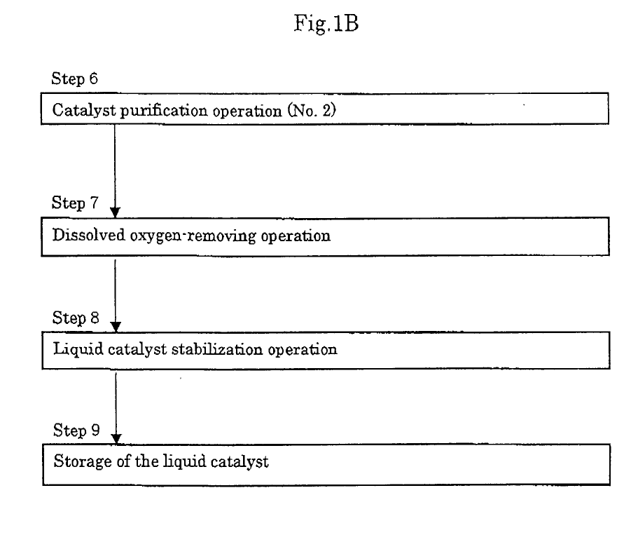

First, production of this liquid catalyst is described by reference to the flowchart in FIGS. 1A and 1B. This production method is an embodiment corresponding to the second aspect of the invention, and first a silver nitrate solution having silver nitrate dissolved in a solvent is mixed with a sodium acetate solution having sodium acetate dissolved in the solvent, to form silver acetate. When the intended oil sample is a petroleum product, a semi-finished petroleum product serving as the starting material thereof or a C₁₋₈ alcohol, the solvent in the liquid catalyst is preferably a petroleum product, a semi-finished petroleum product serving as the starting material thereof or a C₁₋₈ alcohol for the catalyst, and the solvent is more preferably the same type as the oil sample; for example, when the oil sample is a petroleum product, the solvent used in the liquid catalyst is more preferably the same petroleum product. In this example, easily available isopropanol is used as the solvent, and a solution prepared by dissolving 2.1 g silver nitrate in 1 ml water is adjusted to 500 ml with isopropanol (solution A in step 1), while a solution prepared by dissolving 0.4 g sodium acetate in 0.5 ml water is adjusted to 500 ml with isopropanol (solution B in step 2), and the solution A is mixed with the solution B at ordinary temperature, to form silver acetate (white suspended matter) (step 3).

The alcohol for use as the solvent in the catalyst is commercial alcohol such as isopropanol or the like which always contains water, but when its water concentration is low, silver nitrate and sodium acetate are hardly dissolved therein and thus preferably dissolved once in water and then dissolved in isopropanol etc.

Then, the mixed solution is subjected to first filtration to remove the silver acetate. In this example, the solution is filtered through a 0.45 μm millipore filter (step 4).

Then, the silver sulfide-containing silver compounds and silver are precipitated by irradiation with electromagnetic waves or corpuscular rays. The apparatus used for irradiation to electromagnetic waves or corpuscular rays is an embodiment corresponding to the third aspect of this invention. In this example, the sample is irradiated downward with primary X-rays. Using the conventional X-ray fluorescence spectrometer for downward irradiation, 15 ml mixed solution is irradiated downward with X-rays containing the absorption edge wavelength (5.018 Å) of sulfur for 1 hour and then left, whereby silver sulfide-containing silver compounds and silver are precipitated (step 5). That is, S contained as the impurity is reacted by irradiation with the primary X-rays containing X-rays easily absorbed into S, whereby S is precipitated after conversion into (both inorganic and organic) silver compounds mainly containing silver sulfide. Simultaneously, not only other impurities, for example Cl are precipitated as silver chloride, but also (both inorganic and organic) silver compounds such as silver oxide and silver are precipitated, but when X-rays to be irradiated are X-rays having longer wavelengths than the L absorption edge wavelength (3.7 Å) of silver and containing the absorption edge wavelength of sulfur, formation of silver oxide and silver is prevented so that sulfur-containing silver compounds (mainly silver sulfide) can be efficiently precipitated. As the electromagnetic waves or corpuscular rays to be irradiated, high-intensity synchrotron irradiations can be used to treat the mixed solution in a shorter time. When irradiated upward, precipitates can be a hindrance by which the electromagnetic waves or corpuscular rays hardly reach the inside of the mixed solution, so the reaction may be slow. Therefore, downward or lateral irradiation is preferable.

Then, the mixed solution is subjected to second filtration to remove black precipitates which are the precipitated silver sulfide-containing silver compounds and silver. In this example, the solution is filtered through a 0.45 μm millipore filter (step 6). S contained as the impurity is removed as sulfur-containing silver compounds (mainly silver sulfide) and simultaneously the silver compounds such as silver chloride, silver oxide etc. and silver are also removed.

Then, a nitrogen gas is allowed to flow therein to remove dissolved oxygen. In this example, the solution is bubbled for 20 minutes (step 7). Finally, an aldehyde and/or ammonia are added to prevent oxidation and to improve the long-term shelf life. When a petroleum product, a semi-finished petroleum product serving as the starting material thereof or a C₁₋₈ alcohol for the catalyst is used as the solvent, the aldehyde added for preventing oxidation and improving the long-term shelf life is preferably formaldehyde, acetaldehyde or benzaldehyde. In this example, 10 ml benzaldehyde is added (step 8). Because oxidation of the liquid catalyst (specifically silver) is prevented by the steps 7 and 8, deterioration in the performance thereof during storage (step 9) can be reduced. To further suppress the oxidation reaction, the sample is stored preferably in a cool and dark place.

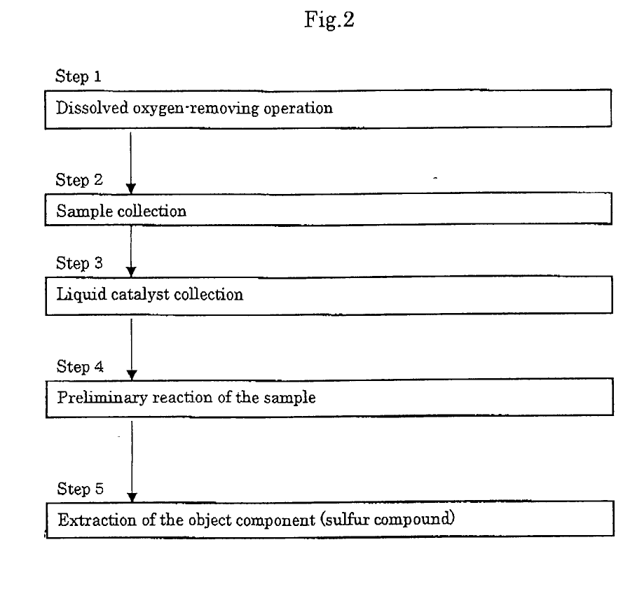

In the method of preparing an oil sample in this embodiment, the procedures shown in the flowchart in FIG. 2 are followed as described below using the liquid catalyst thus prepared. First, a nitrogen gas is allowed to flow into the liquid catalyst to remove dissolved oxygen. This is to prevent silver oxide from occurring later due to oxygen dissolved during storage. In this example, the liquid catalyst is bubbled for 20 minutes (step 1).

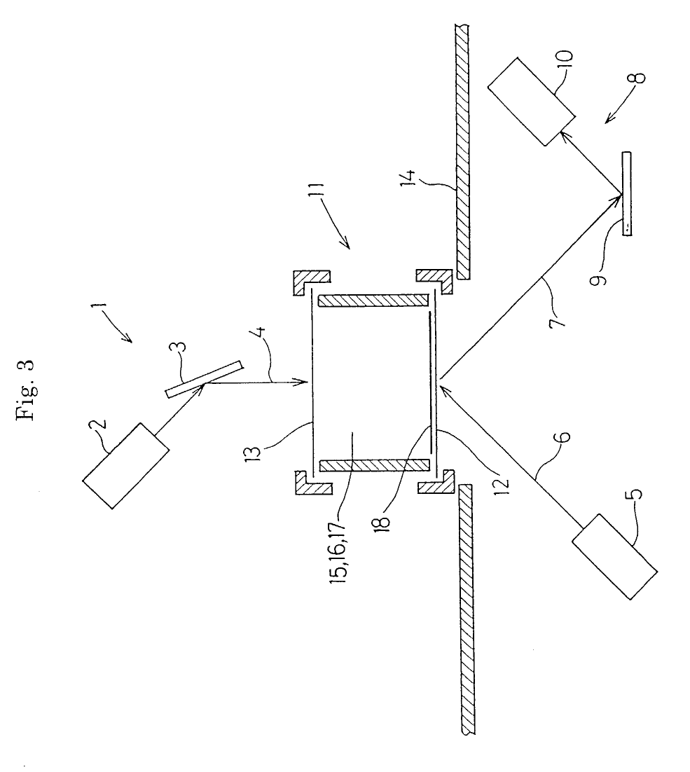

Then, the liquid catalyst is added to and mixed with an oil sample collected in a liquid sample holder (hereinafter referred to simply as sample holder). In this example, 5 ml oil sample is collected in the sample holder (step 2), and 2 ml liquid catalyst is added thereto and stirred (step 3). As shown in the sectional view in FIG. 3, the sample holder 11 is cylindrical and has X-ray-permeable windows (films) 13, 12 attachable and detachable in the top and bottom thereof. Further, the sample holder 11 can also be used as a container in production of the liquid catalyst described above.

Then, the stirred solution is irradiated with electromagnetic waves or corpuscular rays to precipitate silver sulfide-containing silver compounds and silver. In this example, the X-ray fluorescence spectrometer shown in FIG. 3 is used. This spectrometer (apparatus) is an embodiment corresponding to the fifth aspect of the invention, which comprises a pretreatment X-ray source 1 for downward irradiating the stirred solution 15, 16 with X-rays 4 monochromated in the absorption edge wavelength of sulfur as the magnetic waves or corpuscular rays, an analytical X-ray source 5 for upward irradiating a window 12 in the bottom of the sample holder 11 with primary X-rays 6, and a detecting means 8 for detecting fluorescent X-rays 7 emitted from the oil sample prepared.

The pretreatment X-ray source 1 includes an X-ray tube 2 for emitting X-rays containing the absorption edge wavelength of sulfur and a spectroscopic device 3 for monochromating X-rays emitted from the X-ray tube 2 thus providing X-rays 4 monochromated in the absorption edge wavelength of sulfur. X-rays may be monochromated not only by the spectroscopic device but also by a secondary target system for emitting fluorescent X-rays by irradiating a target material with X-rays from the X-ray tube. A secondary target material containing K, Ca, Ru, Rh etc. is desirable. The detecting means 8 includes a spectroscopic device 9 for monochromating fluorescent X-rays 7 to the fluorescent X-rays of S and a detector 10 for measuring the intensity of the monochromated fluorescent X-rays of S. The sample holder 11 is mounted on a sample stand 14 having a hole corresponding to the window 12 in the bottom thereof.

This spectrometer is used to irradiate the stirred solution 15, 16 with the electromagnetic waves or corpuscular rays 4 to precipitate silver sulfide-containing silver compounds and silver.

In this example, the stirred solution 15, 16 is irradiated for 30 minutes downward with the X-rays 4 monochromated in the absorption edge wavelength of sulfur (step 4 in FIG. 2). That is, S contained in the oil sample 16 is reacted by irradiation with the X-rays 4 easily absorbed into S, whereby S is precipitated by conversion into (both inorganic and organic) silver compounds mainly containing silver sulfide.

By this step, not only other materials (impurities),for example Cl contained in the oil sample 16 are precipitated as silver chloride, but also (both inorganic and organic) silver compounds such as silver oxide etc. and silver are precipitated. When the sulfur-free silver compounds and silver remain precipitated, they cause scattering rays during analysis or absorb the fluorescent X-rays of S, thus interfering with accurate analysis of a very small amount of S, and therefore they will be dissolved in the procedure described later.

Because a lower amount of precipitates are preferable for dissolving them in a shorter time, the solution 15, 16 are irradiated with the X-rays 4 monochromated in the absorption edge wavelength of sulfur so that particularly S can be efficiently reacted. In the next best approach, the solution 15, 16 may be irradiated with X-rays not monochromated but having longer wavelengths than the L absorption edge wavelength of silver and containing the absorption edge wavelength of sulfur. As described above, when irradiated upward, the precipitates can be a hindrance by which the electromagnetic waves or corpuscular rays hardly reach the inside of the solution 15, 16, and thus the reaction may be slow. Therefore, downward or lateral irradiation is preferable, and in this example, downward irradiation is used.

However, for example, a conventional upward irradiating X-ray fluorescence spectrometer for upward irradiating the sample with primary X-rays (that is, the same apparatus as in FIG. 3 except that the pretreatment X-ray source 1 is absent) can be used so that both preparation and subsequent analysis of the oil sample can be easily carried out. In this case, the analytical X-ray source 5 also serves as the pretreatment X-ray source 1, by which the solution 15, 16 is irradiated upward with the primary X-rays 6 i.e. X-rays containing the absorption edge wavelength of sulfur thereby precipitating silver sulfide-containing silver compounds and silver.

Then, ammonia and/or an aldehyde 17 is added to dissolve the silver compounds other than silver sulfide-containing sulfur compound and silver, whereby the silver sulfide-containing sulfur compound 18 is left as precipitates on the window 12 in the bottom of the sample holder 11. In this example, benzaldehyde 17 is added to the sample and left at a constant temperature (30° C.) for about 20 hours thereby causing suitable convection to dissolve precipitates other than the silver sulfide-containing sulfur compound. The sample is left for about 20 hours as described above in the case of precipitation of sulfur-free silver compounds and silver in a large amount, but may be left in a shorter time when the amount of sulfur-free silver compounds and silver is made lower by e.g. irradiation with X-rays 4 monochromated in the absorption edge wavelength of sulfur. The sulfur compound 18 mainly containing silver sulfide is left as precipitates on the window 12 in the bottom of the sample holder 11 (step 5 in FIG. 2). The sulfur compound 18 mainly containing silver sulfide is used as a sample for X-ray fluorescence analysis.

That is, the X-ray fluorescence spectrometer in FIG. 3 or the conventional upward irradiating X-ray fluorescence spectrometer used in step 4 is then used to upward irradiate the window 12 in the bottom of the sample holder 11 with primary X-rays 6, and then to measure the intensity of the fluorescent X-rays 7 of S emitted from the silver sulfide-containing sulfur compound 18 remaining as precipitates. Thus, the irradiation with the electromagnetic waves or corpuscular rays for preparation (pretreatment) (for example, with X-rays 4 monochromated in the absorption edge wavelength of sulfur, or with X-rays 6 containing the absorption edge wavelength of sulfur), and the irradiation with primary X-rays 6 for analysis of the oil sample prepared, can be carried out by one apparatus.

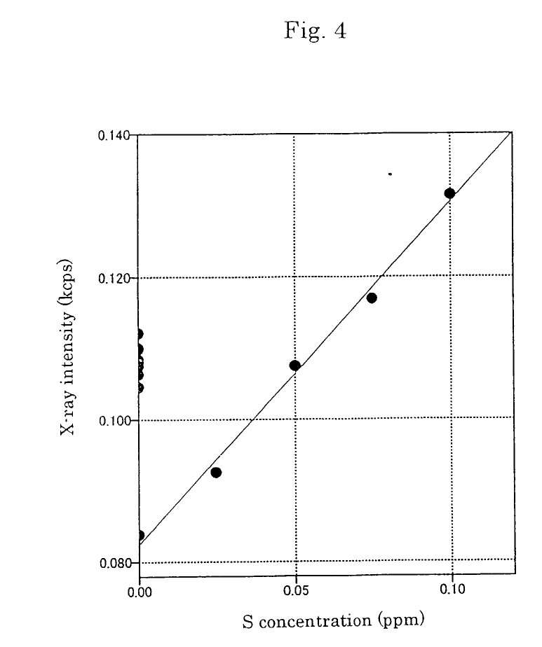

FIG. 4 shows a calibration curve prepared by preparing 5 kinds of standard oil samples whose standard values of S were 0, 25, 50, 75 and 100 ppb by the preparation method in this embodiment and then analyzing the concentrations of S therein, wherein the liquid catalyst was produced using the conventional downward irradiating X-ray fluorescence spectrometer, and the oil samples were prepared and analyzed using the conventional upward irradiating X-ray fluorescence spectrometer. Although the concentrations of S are as very low as several 10 ppb levels, a considerably linear calibration curve can be prepared. Then, 10 oil samples in sample holders (n=1 to 10) were prepared in the same manner as for the standard oil samples by diluting DBDS (C₄H₉—S—S—C₄H₉) with isopropanol to adjust the concentration of S to 50 ppb, and using the preparation method in this embodiment by, and the concentration of S in these oil samples was analyzed by reference to the above calibration curve. The result is shown in Table 1. As can be seen from this result, repeatability as high as a σ value of 5.15 and a CV value of 9.6 can be achieved although the concentration of S is as very low as 50 ppb (0.05 ppm).

TABLE 1

| | DBDS diluted with |
|---|---|
| Sample | isopropyl alcohol |
| n = 1 | 49.9 |
| n = 2 | 54.1 |
| n = 3 | 46.2 |
| n = 4 | 53.3 |
| n = 5 | 52.2 |
| n = 6 | 61.9 |
| n = 7 | 46.1 |
| n = 8 | 57.5 |
| n = 9 | 57.2 |
| n = 10 | 57.4 |
| ave | 53.6 |
| σ | 5.15 |
| CV % | 9.6 |
| Preparation value (ppb) | 50 |
| Measurement day | 2001/3/9 |

According to the method of preparing an oil sample in the first embodiment as described above, the liquid catalyst 15 from which S was almost completely removed is used whereby S contained in the oil sample 16 is extracted, sedimented and concentrated as a silver sulfide-containing sulfur compound 18, and therefore S in a very small amount of about 10 ppb can be analyzed.

Now, the method of preparing an oil sample in the second embodiment of the invention (corresponding to the sixth aspect of the invention) is described. This method of preparing an oil sample is the same as the method of preparing an oil sample in the first embodiment (corresponding to the fourth aspect of the invention) until the liquid catalyst is added to an oil sample collected in a container, and they are stirred to be irradiated with X-rays as the electromagnetic waves or corpuscular rays. In this embodiment, it is to be noted that the container for collecting the oil sample may be any one in which the liquid catalyst added can be stirred and irradiated with X-rays, so the container is not limited to the liquid sample container (sample holder 11 in FIG. 3) for X-ray fluorescence analysis. As the X-rays used for irradiation to the stirred solution, are employed X-rays containing the absorption edge wavelength (5.018 Å) of sulfur, which are irradiated downward as primary X-rays by the conventional downward irradiating X-ray fluorescence spectrometer.

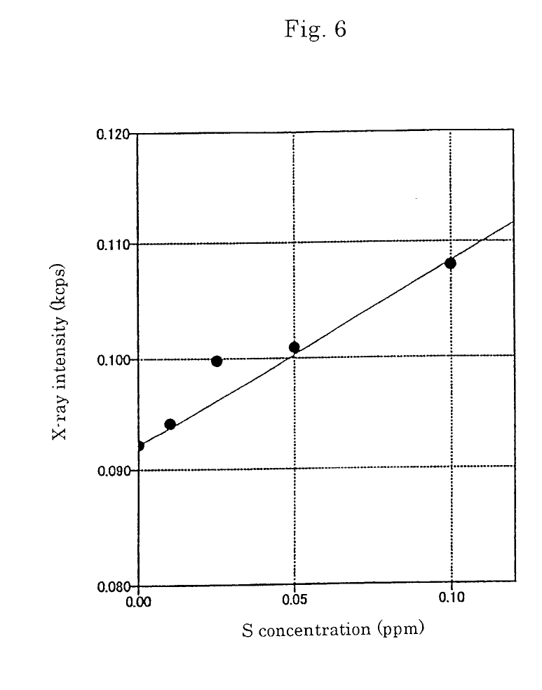

As described below, the solution after irradiation with X-rays is then subjected to suction filtration with a filter membrane, whereby silver sulfide-containing silver compounds and silver are separated on the filter membrane. As shown in FIG. 7, a funnel 23 is first attached to and sealed with a flask (Buchner flask) 21 via a rubber plug 22 and a glass ground joint, and then a sample preparation holder 25 is mounted via a mesh member 24 on the bunghole of the funnel 23. The funnel 23, the mesh member 24 and the sample preparation holder 25 are also sealed therebetween with a rubber member.

A filter membrane 26, that is, a polymer porous membrane, a millipore filter, a filter paper or a filter cloth is spread on the sample preparation holder 25. Because the filter membrane 26 which together with the separated material, is irradiated with X-rays as described later should be free of S as the object of analysis, a biaxial oriented polymer porous membrane made of polyethylene or polypropylene is preferable as membrane 26 and used in this example. In X-ray fluorescence analysis, however, S at a deeper position than 0.06 mm is not detected, while the amount of the oil sample is easily increased such that the material separated by filtration is made thicker than 0.06 mm, so that a S-containing polymer porous membrane, millipore filter, filter paper or filter cloth can also be used as the filter membrane 26 by controlling the amount of the oil sample such that the material separated therefrom is made thicker than 0.06 mm in order to prevent S contained in the membrane from influencing the analysis.

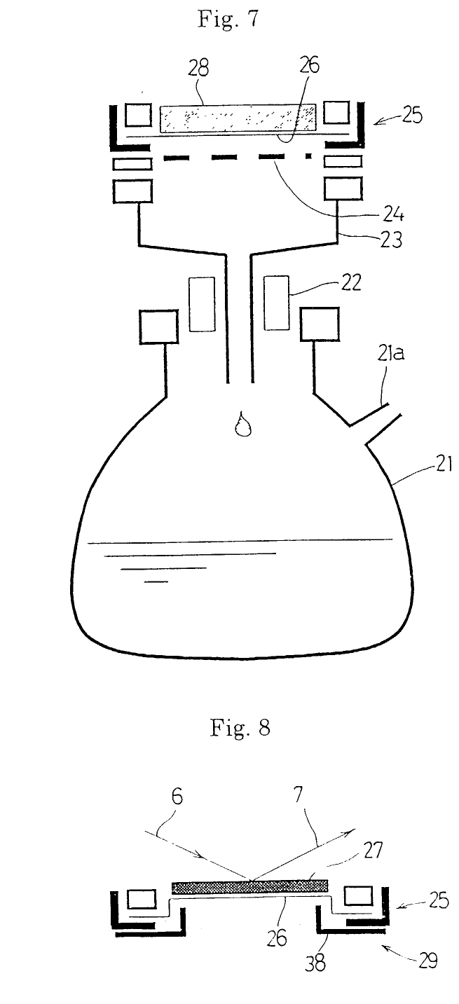

Then, the solution 28 irradiated with X-rays is poured onto the filter membrane 26 and simultaneously subjected to suction filtration by evacuation via a suction hole 21a of the flask 21 with e.g. a vacuum pump and an aspirator attached to the X-ray fluorescence spectrometer. By this suction filtration, the silver sulfide-containing silver compounds and silver 27 are separated on the filter membrane 26, as shown in FIG. 8. That is, S contained in the oil sample is concentrated and coated as a part of the separated material on the filter membrane 26 in the sample preparation holder 25, and thus a base member 38 is attached upward to the sample preparation holder 25, and the filter membrane 26 and the separated material 27 are raised, to construct a sample measurement holder 29. The sample measurement holder 29 is mounted on a sample stand in the downward irradiating X-ray fluorescence spectrometer so that the intensities of the fluorescent X-rays 7 emitted upon downward irradiation to the separated material 27 with primary X-rays 6 can be measured. The separated material 27 adheres to the filter membrane 26 and does not fall even if the sample measurement holder 29 is in a downward direction, and thus the separated material 27 can also be analyzed by the upward irradiating X-ray fluorescence spectrometer.

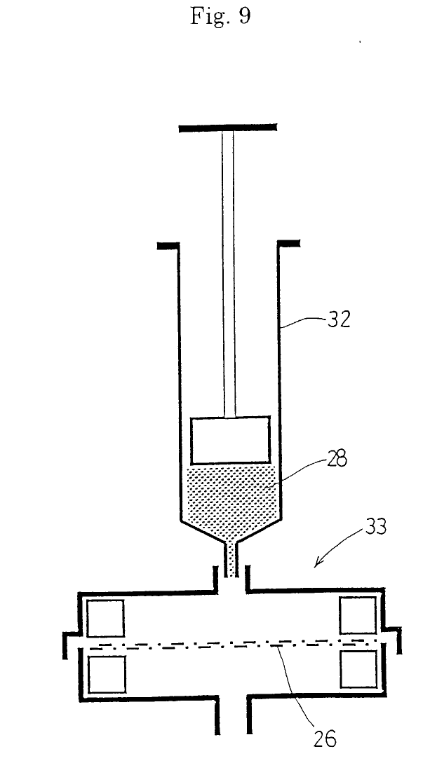

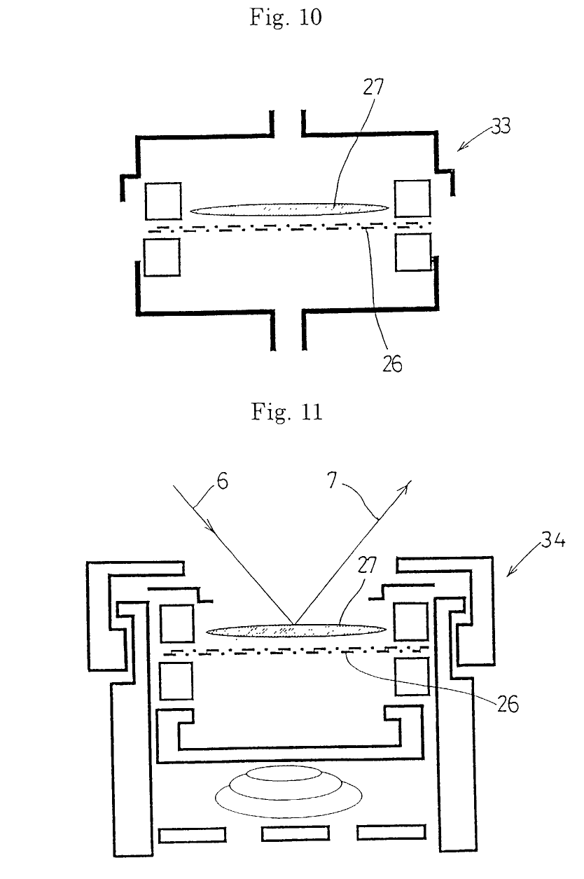

In the method of preparing an oil sample in the second embodiment, filtration may be conducted by pressure filtration. For example, as shown in FIG. 9, the solution 28 irradiated with the X-rays is sucked in a syringe 32, and a filtration cartridge 33 having the filter membrane 26 integrated therein is attached to the top of the syringe 32, and the solution 28 in the syringe 32 is pushed out for pressure filtration. The filter membrane 26 may be the same as in suction filtration. As a result of pressure filtration, silver sulfide-containing silver compounds and silver 27 are separated on the filter membrane 26 as shown in FIG. 10. That is, S contained in the oil sample is concentrated and coated as a part of the separated material on the filter membrane 26 in the filtration cartridge 33, and this filtration cartridge 33 is disassembled to remove the filter membrane 26, and as shown in FIG. 11, the filter membrane 26 is integrated into a sample holder (referred to hereinafter as solid sample holder) 34 used for conventional solid samples, and then mounted on a sample stand in the downward-irradiating X-ray fluorescence spectrometer so that the intensities of the fluorescent X-rays 7 emitted upon downward irradiation to the separated material 27 with primary X-rays 6 can be measured. Alternatively, while the solid sample holder 34 is in a downward direction, the separated material 27 can be analyzed in the same manner as in suction filtration by the upward irradiating X-ray fluorescence spectrometer. Further, filtration may be conducted easily by filtration at normal pressure with a similar filtration member 26 although the filtration time is prolonged.

According to the method of preparing an oil sample in the second embodiment as described above, the same liquid catalyst as in the first embodiment, from which S was removed almost completely, is used whereby S contained in the oil sample is extracted, filtered and concentrated thus giving fluorescent X-ray intensity enough to measure S, but unlike the preparation method in the first embodiment, re-dissolution of precipitates other than sulfur compounds is not conducted. Accordingly, the minimum limit of determination is made about 15 ppb, but a very small amount of S can also be analyzed and the measurement sample can be prepared rapidly and easily. Further, unlike the preparation method in the first embodiment, S contained in the oil sample is concentrated by filtration and can thus be prepared more rapidly without waiting sedimentation, and S contained in the oil sample is not precipitated on the window (downward in the solution) in the bottom of the sample holder (liquid sample holder), but separated and stuck as solid on the filter membrane, and can thus be analyzed by the X-ray fluorescence spectrometer for not only upward but also downward irradiation.

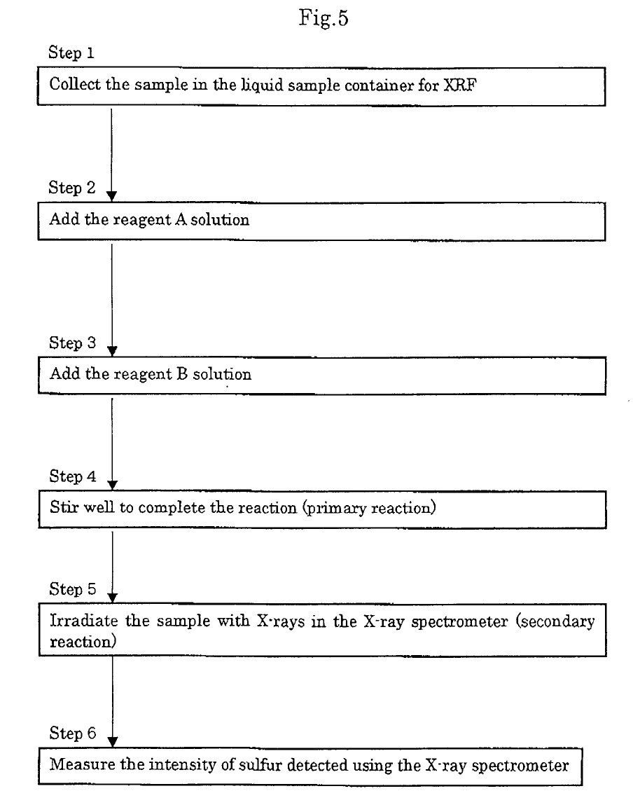

Then, the X-ray fluorescence analysis method in the third embodiment of the invention (corresponding to the ninth aspect of the invention) is described by reference to the flowchart in FIG. 5. This X-ray fluorescence analysis method includes an embodiment of the method of preparing an oil sample in the seventh aspect of the invention. In this X-ray fluorescence analysis method, a silver nitrate solution having silver nitrate dissolved in a solvent and a sodium acetate solution having sodium acetate dissolved in the solvent are added as the liquid catalyst to the oil sample collected in the sample holder and then stirred. When the oil sample is a petroleum product, a semi-finished petroleum product serving as the starting material thereof or a C₁₋₈ alcohol, the solvent in the liquid catalyst is preferably a C₁₋₈ alcohol for the solvent. In this example, isopropanol (isopropyl alcohol) easily available is used as the solvent.

That is, 2 ml oil sample is collected in a liquid sample container (sample holder 11 in FIG. 3) for X-ray fluorescence analysis (XRF) (step 1), and 2 ml sodium acetate solution prepared by dissolving sodium acetate in water and then diluting it with isopropanol is added as the liquid catalyst (reagent A solution) (step 2), while 2 ml silver nitrate solution prepared by dissolving silver nitrate in water and then diluting it with isopropanol is added as the liquid catalyst (reagent B solution) (step 3), and the mixture is stirred to form suspended silver acetate (step 4). The reason that sodium acetate and silver nitrate are dissolved once in water is the same as described above.

Then, the window in the bottom of the sample holder is irradiated upward with primary X-rays to precipitate silver sulfide-containing silver compounds and silver on the window, and simultaneously the intensities of the emitted fluorescent X-rays are measured. In this example, the conventional upward irradiating X-ray fluorescence spectrometer for upward irradiating the sample with primary X-rays (the same apparatus as in FIG. 3 except that the pretreatment X-ray source 1 is absent) is used. That is, the analytical X-ray source 5 also serves as the pretreatment X-ray source, and the window 12 in the bottom of the sample holder 11 is irradiated upward with primary X-rays 6 i.e. X-rays containing the absorption edge wavelength of sulfur, whereby silver sulfide-containing silver compounds and silver are precipitated on the window 12 (step 5), and simultaneously the intensity of the fluorescent X-rays 7 of S emitted from the precipitates is measured (step 6).

The intensity of the fluorescent X-rays 7 may be measured when the saturation of the intensity is confirmed by monitoring the intensity, that is, when sedimentation is completed, or more rapidly at a predetermined time, for example 2 minutes after irradiation with primary X-rays is initiated. In either case, the procedures starting from preparation of a standard curve by measuring standard samples are conducted consistently.

FIG. 6 shows a calibration curve prepared by preparing 5 kinds of standard oil samples whose standard values of S were 0, 10, 25, 50 and 100 ppb respectively and then analyzing the concentrations of S therein by the X-ray fluorescence analysis method in the third embodiment. Although the concentrations of S are as very low as several 10 ppb levels, a considerably linear calibration curve can be prepared. Then, 10 oil samples in sample holders (n=1 to 10) were prepared as the oil sample by diluting kerosine with isopropanol to adjust the concentration of S to 30 ppb, and by the X-ray fluorescence analysis method in the third embodiment, these oil samples were pretreated in the same manner as for the standard oil samples and then analyzed for the concentration of S therein by reference to the above calibration curve. The result is shown in Table 2. As can be seen from this result, repeatability as high as a σ value of 9.83 and a CV value of 27.9 can be achieved although the concentration of S is as very low as 30 ppb (0.03 ppm).

TABLE 2

| | Kerosine diluted with |
|---|---|
| Sample | isopropyl alcohol |
| n = 1 | 41.1 |
| n = 2 | 26.9 |
| n = 3 | 38.4 |
| n = 4 | 35.2 |
| n = 5 | 43.2 |
| n = 6 | 18.7 |
| n = 7 | 42.4 |
| n = 8 | 31.4 |
| n = 9 | 24.3 |
| n = 10 | 50.5 |
| ave | 35.2 |
| σ | 9.83 |
| CV % | 27.9 |
| Preparation value (ppb) | 30 |
| Measurement day | 2001/2/20 |

In the X-ray fluorescence analysis method in the third embodiment as described above, S contained in the oil sample is extracted, sedimented and concentrated thus giving fluorescent X-ray intensity enough to measure S, but unlike the preparation method in the first embodiment, removal of S contained in the reagents and re-dissolution of precipitates other than sulfur compounds are not conducted. Further, the conventional upward irradiating X-ray fluorescence spectrometer can be used in both irradiation of X-rays for preparation (pretreatment) and irradiation of primary X-rays for analysis of the oil sample prepared. Accordingly, S in a very small amount of about 30 ppb can be analyzed rapidly and easily.

Now, the method of preparing an oil sample in the fourth embodiment of this invention (corresponding to the eighth aspect of the invention) is described. This method of preparing an oil sample is the same as the method of preparing an oil sample (used in the X-ray fluorescence analysis method in the third embodiment) in the seventh aspect of the invention until the liquid catalyst is added to an oil sample collected in the container, and they are stirred to be irradiated with X-rays as the electromagnetic waves or corpuscular rays. However, the irradiation with X-rays for preparation (pretreatment) is not carried out simultaneously with the irradiation with primary X-rays for analysis of the oil sample prepared, so it is not necessary that the container for collection of the oil sample is a liquid sample container (sample holder 11 in FIG. 3) for X-ray fluorescence analysis. In this example, as the X-rays used for irradiation to the stirred solution, are employed primary X-rays containing the absorption edge wavelength (5.018 Å) of sulfur, which are irradiated downward by the conventional downward irradiating X-ray fluorescence spectrometer. In the same manner as in the preparation method in the second embodiment, the solution irradiated with the X-rays is filtered through a filter membrane under suction, under pressure or at normal pressure, to separate silver sulfide-containing silver compounds and silver on the filter membrane.

In the method of preparing an oil sample in the fourth embodiment, S contained in the oil sample is extracted, filtered and concentrated thus giving fluorescent X-ray intensity enough to measure S, but like the X-ray fluorescence analysis method in the third embodiment, removal of S contained in the reagents and re-dissolution of precipitates other than sulfur compounds are not conducted. Further, S contained in the oil sample is concentrated by filtration, thus eliminating the time necessary for sedimentation. Accordingly, S in a very small amount of about 30 ppb can be analyzed rapidly and easily. Further, S contained in the oil sample is not precipitated on the window (downward in the solution) in the bottom of the sample holder (liquid sample holder), but separated and stuck as solid on the filter membrane, and can thus be analyzed by the X-ray fluorescence spectrometer for not only upward but also downward irradiation.

The preferable embodiments have been described by reference to the drawings, and in view of the present specification, those skilled in the art could easily anticipate various modifications and alterations within the evident scope of this invention. Accordingly, such modifications and alterations are construed to be within the scope of this invention defined by the appended claims.

What is claimed is:

1. A liquid catalyst used in a method of preparing an oil sample for X-ray fluorescence analysis of the concentration of sulfur in said oil sample,
which is prepared by removing silver acetate, and silver sulfide-containing silver compounds and silver precipitated by irradiation with electromagnetic waves or corpuscular rays, by filtration from a mixed solution of a silver nitrate solution having silver nitrate dissolved in a solvent and a sodium acetate solution having sodium acetate dissolved in said solvent.

2. The liquid catalyst according to claim 1, wherein;
said oil sample is a petroleum product, a semi-finished petroleum product serving as the starting material thereof or a C₁₋₈ alcohol, and
said solvent is a petroleum product, a semi-finished petroleum product serving as the starting material thereof or a C₁₋₈ alcohol for the catalyst.

3. A method of producing the liquid catalyst according to claim 1, comprising:
mixing a silver nitrate solution having silver nitrate dissolved in a solvent with a sodium acetate solution having sodium acetate dissolved in said solvent to form silver acetate,
subjecting the mixed solution to first filtration to remove said silver acetate,
irradiating the solution with electromagnetic waves or corpuscular rays to precipitate silver sulfide-containing silver compounds and silver,
subjecting the solution to second filtration to remove said silver compounds and silver,
allowing a nitrogen gas to flow into the solution to remove dissolved oxygen, and
adding an aldehyde or ammonia for preventing oxidation and improving the long-term shelf life.

4. The method of preparing a liquid catalyst according to claim 3, wherein:
said oil sample is a petroleum product, a semi-finished petroleum product serving as the starting material thereof or a C₁₋₈ alcohol,
said solvent is a petroleum product, a semi-finished petroleum product serving as the starting material thereof or a C₁₋₈ alcohol for the catalyst,
said electromagnetic waves or corpuscular rays are X-rays having longer wavelengths than the L absorption edge wavelength of silver and containing the absorption edge wavelength of sulfur, and
said aldehyde is formaldehyde, acetaldehyde or benzaldehyde.

5. An apparatus for producing the liquid catalyst according to claim 1, comprising a radiation source for purifying the catalyst, to irradiate said mixed solution with the electromagnetic wavers or corpuscular rays in order to precipitate said silver sulfide-containing silver compounds and silver.

6. The apparatus for producing a liquid catalyst according to claim 5, wherein said radiation source for purifying the catalyst is an X-ray source for purifying the catalyst to irradiate X-rays having longer wavelengths than the L absorption edge wavelength of silver and containing the absorption edge wavelength of sulfur.

7. A method of preparing an oil sample for X-ray fluorescence analysis of the concentration of sulfur in said oil sample, comprising:
allowing a nitrogen gas to flow into the liquid catalyst according to claim 1 to remove dissolved oxygen,
adding the liquid catalyst to said oil sample collected in a sample holder and stirring them,
irradiating the stirred solution with electromagnetic waves or corpuscular rays to precipitate silver sulfide-containing silver compounds and silver, and
adding ammonia or an aldehyde to dissolve silver compounds and silver other than silver sulfide-containing sulfur compounds, whereby the silver sulfide-containing sulfur compounds are left as precipitates on a window in the bottom of said sample holder.

8. The method of preparing an oil sample according to claim 7, wherein:
said oil sample is a petroleum product, a semi-finished petroleum product serving as the starting material thereof or a C₁₋₈ alcohol,
the solvent in said liquid catalyst is a petroleum product, a semi-finished petroleum product serving as the starting material thereof or a C₁₋₈ alcohol for the catalyst, and
the electromagnetic waves or corpuscular rays for irradiation to said stirred solution are X-rays having longer wavelengths than the L absorption edge wavelength of silver and containing the absorption edge wavelength of sulfur.

9. An X-ray fluorescence spectrometer for analyzing the concentration of sulfur in an oil sample by the preparation method described in claim 7, comprising:
a pretreatment radiation source for downward irradiating said stirred solution with said electromagnetic waves or corpuscular rays, and
an analytical X-ray source for upward irradiating a window in the bottom of said sample holder with primary X-rays.

10. An X-ray fluorescence spectrometer for analyzing the concentration of sulfur in an oil sample by the preparation method according to claim 8, comprising:
a pretreatment X-ray source for downward irradiating said stirred solution with the X-rays having longer wavelengths than said L absorption edge wavelength of silver and containing the absorption edge wavelength of sulfur, and
an analytical X-ray source for upward irradiating a window in the bottom of said sample holder with primary X-rays.

11. The X-ray fluorescence spectrometer according to claim 10, wherein the X-rays irradiated by said pretreatment X-ray source are X-rays monochromated in the absorption edge wavelength of sulfur.

12. A method of preparing an oil sample for X-ray fluorescence analysis of the concentration of sulfur in said oil sample, comprising:
allowing a nitrogen gas to flow into the liquid catalyst according to claim 1 to remove dissolved oxygen,
adding the liquid catalyst to said oil sample and stirring them, and
irradiating the stirred solution with electromagnetic waves or corpuscular rays and filtering the solution through a filter membrane, to separate silver sulfide-containing silver compounds and silver on said filter membrane.

13. The method of preparing an oil sample according to claim 12, wherein:
said oil sample is a petroleum product, a semi-finished petroleum product serving as the starting material thereof or a C₁₋₈ alcohol,
the solvent in said liquid catalyst is a petroleum product, a semi-finished petroleum product serving as the starting material thereof or a C₁₋₈ alcohol for the catalyst, and
the electromagnetic waves or corpuscular rays for irradiation to said stirred solution are X-rays having longer wavelengths than the L absorption edge wavelength of silver and containing the absorption edge wavelength of sulfur.

14. A method of preparing an oil sample for X-ray fluorescence analysis of the concentration of sulfur in said oil sample, comprising:
adding a silver nitrate solution having silver nitrate dissolved in a solvent and a sodium acetate solution having sodium acetate dissolved in said solvent, as a liquid catalyst to said oil sample collected in a sample holder and stirring them, and
irradiating the stirred solution with electromagnetic waves or corpuscular rays to precipitate silver sulfide-containing silver compounds and silver on a window in the bottom of said sample holder.

15. The method of preparing an oil sample according to claim 14, wherein:
said oil sample is a petroleum product, a semi-finished petroleum product serving as the starting material thereof or a C₁₋₈ alcohol,
said solvent is a C₁₋₈ alcohol for the catalyst, and
said electromagnetic waves or corpuscular rays for irradiation to said stirred solution are X-rays having longer wavelengths than the L absorption edge wavelength of silver and containing the absorption edge wavelength of sulfur.

16. The method of preparing an oil sample according to claim 15, wherein the X-rays for irradiation to said stirred solution are X-rays monochromated in the absorption edge wavelength of sulfur.

17. A method of preparing an oil sample for X-ray fluorescence analysis of the concentration of sulfur in said oil sample, comprising:
adding a silver nitrate solution having silver nitrate dissolved in a solvent and a sodium acetate solution having sodium acetate dissolved in said solvent, as a liquid catalyst to said oil sample and stirring them, and
irradiating the stirred solution with electromagnetic waves or corpuscular rays and filtering the solution through a filter membrane, to separate silver sulfide-containing silver compounds and silver on said filter membrane.

18. The method of preparing an oil sample according to claim 17, wherein:
said oil sample is a petroleum product, a semi-finished petroleum product serving as the starting material thereof or a C₁₋₈ alcohol,
said solvent is a C₁₋₈ alcohol for the catalyst, and
the electromagnetic waves or corpuscular rays for irradiation to said stirred solution are X-rays having longer wavelengths than the L absorption edge wavelength of silver and containing the absorption edge wavelength of sulfur.

19. The method of preparing an oil sample according to claim 18, wherein the X-rays for irradiation to said stirred solution are X-rays monochromated in the absorption edge wavelength of sulfur.

20. An X-ray fluorescence analysis method for analyzing the concentration of sulfur in the oil sample, comprising:
adding a silver nitrate solution having silver nitrate dissolved in a solvent and a sodium acetate solution having sodium acetate dissolved in said solvent, as a liquid catalyst to the oil sample collected in a sample holder and stirring them,
upward irradiating a window in the bottom of said sample holder with primary X-rays to precipitate silver sulfide-containing silver compounds and silver on said window while measuring the intensities of fluorescent X-rays emitted from the oil sample.

21. The X-ray fluorescence analysis method according to claim 20, wherein:
said oil sample is a petroleum product, a semi-finished petroleum product serving as the starting material thereof or a C₁₋₈ alcohol, and
said solvent is a C₁₋₈ alcohol for the catalyst.
